(19) United States
(12) Patent Application Publication
(10) Pub. No.: US 2025/0307377 A1
(43) Pub. Date: Oct. 2, 2025

(54) TECHNIQUES FOR MULTI-PERSPECTIVE EVALUATION OF LOGIN DATA

(71) Applicant: WELLS FARGO BANK, N.A., San Francisco, CA (US)

(72) Inventors: Matthew Heffron, Bishop, GA (US); Nurujjama Beg, Plano, TX (US); Ramesh Yarlagadda, Charlotte, NC (US); Dennis E. Montenegro, Concord, CA (US); Sadie S. Salim, Mill Valley, CA (US); Jennifer Toby Whateley, Fremont, CA (US)

(21) Appl. No.: 18/617,904

(22) Filed: Mar. 27, 2024

(51) Int. Cl. G06F 21/45

(52) U.S. Cl. CPC G06F 21/45

(57) ABSTRACT

A multi-perspective login data evaluation computing system receives candidate login data for a secured service or a secured computing system. The multi-perspective evaluation system includes a mnemonic generation model and a mnemonic evaluation model. The mnemonic generation model generates, based on features of the candidate login data, candidate mnemonic data that includes media data associated with the candidate login data. The mnemonic evaluation model generates, based on features of the mnemonic guess features, login guess data that includes at least one text string or other login guess data object that describes a potential interpretation of the candidate mnemonic data. The multi-perspective evaluation system provides one or more of the candidate mnemonic data or the login guess data to an additional computing system. In some cases, the multi-perspective evaluation system provides user profile data that is based on the candidate login data.

### TECHNICAL FIELD

This disclosure relates generally to the field of computing security, and more specifically relates to machine-learning evaluation of login data.

### BACKGROUND

In many cases, secured computing systems and secured services offered by computing systems utilize login data for improved security for the secured systems or services. For example, a secured computing system can require a username, password, a security question/answer combination, biometric data, or other types of login data before permitting access by an additional computing system. However, a person who utilizes the secured computing system, e.g., by logging in via the additional computing system, may experience difficulty remembering the login data that is required by the secured computing system. In some cases, this can inadvertently encourage the person to select login data that is has relatively low security. Examples of login data with relatively low security include simplistic login data (e.g., passwords with few characters), login data that is reused across multiple computing systems, login data that is readily guessable based on a correlation to the person's public interests (e.g., posts on social media), or other types of relatively insecure login data.

It is desirable to develop techniques to assist users with selecting login data having increased security, such as technical tools to improve memory assistance for recalling relatively complex login data.

### SUMMARY

According to certain embodiments, a multi-perspective login data evaluation computing system receives candidate login data for a secured service or a secured computing system. A mnemonic generation model included in the multi-perspective evaluation system generates one or more candidate login features that describe one or more characteristics of the candidate login data. The mnemonic generation model generates, based on the candidate login features, candidate mnemonic data that includes media data associated with the candidate login data. A mnemonic evaluation model included in the multi-perspective evaluation system generates one or more mnemonic guess features that describe one or more characteristics of the candidate mnemonic data. The mnemonic evaluation model generates, based on the mnemonic guess features, login guess data that includes at least one login guess data object describing a potential interpretation of the candidate mnemonic data. The multi-perspective evaluation system provides one or more of the candidate mnemonic data or the login guess data to an additional computing system. The multi-perspective evaluation system receives data indicating at least one relationship among the candidate login data, the candidate mnemonic data, and the login guess data. Based on the received data indicating the relationship, the multi-perspective evaluation system provides user profile data that is based on the candidate login data.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings, where:

FIG. 1 is a diagram depicting an example of a computing environment in which a multi-perspective login data evaluation computing system evaluates a relative security of generated mnemonic data, according to certain embodiments;

FIG. 2 is a diagram depicting an example of a multi-perspective login data evaluation computing system configured to control data access among multiple trained machine learning models, according to certain embodiments;

FIG. 3 is a flow chart depicting an example of a process for generating data objects for multi-perspective evaluation of login data, according to certain embodiments;

FIG. 4 is a flow chart depicting an example of a process, or portion of a process, for modifying data objects for additional multi-perspective evaluation of login data, according to certain embodiments; and

FIG. 5 is a block diagram depicting an example of a computing system for implementing a multi-perspective login data evaluation computing system, according to certain embodiments.

### DETAILED DESCRIPTION

As discussed above, it is desirable to develop techniques and technical tools to assist users in selection of login data with relatively high security, and to provide memory assistance for the relatively high-security login data. Contemporary systems for selection of login information may rely on relatively unsophisticated techniques, such as security question/answer questions that are selected from a preexisting list, text-based mnemonics to cue a user's recollection of login data, or other text-based attempts to address the problem of poor user recollection. However, these contemporary systems for login information selection do not provide a high level of security, as text-based mnemonics or selection from preexisting lists may be relatively easy for malicious parties to guess, determine via automated trial-and-error (e.g., “brute-force”) or other systematic approaches, or otherwise circumvent. In addition, contemporary systems for login information selection may provide insufficient flexibility for users who desire to select login information with relatively high security but who feel uncomfortable memorizing relatively complex passwords or other types of login information. In some cases, contemporary systems for login information selection do not provide adequate support for users who prefer a language that is different from a language utilized by a secured computing system, or for users who have relatively low affinity for text, such as users who experience forms of dyslexia or synesthesia.

Certain embodiments described herein provide for techniques to provide multi-perspective evaluation of login information, such as candidate login data that is provided (e.g., via a user computing system) by a user who desires to generate user profile data to access a secured service (e.g., via a secured computing system). In some cases, the described techniques for multi-perspective evaluation of login information can include assistive evaluation, such as generating candidate mnemonic data that can provide memory assistance for the candidate login data. In addition, the described techniques for multi-perspective evaluation of login information can include adversarial evaluation, such as generating login guess data that describes potential interpretations of the candidate mnemonic data. A multi-perspective login data evaluation computing system (also referred to herein as a “multi-perspective evaluation system”) can include multiple trained machine-learning models that provide multiple perspectives of assistive evaluation and adversarial evaluation for the candidate login data. In some cases, a user who utilizes the multi-perspective evaluation system can provide additional input data to modify one or more of the candidate mnemonic data or the candidate login data, such as modification data or prompt data. The multi-perspective evaluation system can provide additional assistive evaluation of the input data, such as modifying the candidate mnemonic data based on requested changes indicated by the input data. In addition, the multi-perspective evaluation system can provide additional adversarial evaluation of the input data, such as modifying the login guess data to describe additional potential interpretations of the modified candidate mnemonic data. In some cases, the multi-perspective evaluation system can improve security for login data selected by the user, such as by increasing memory assistance by modifying the candidate mnemonic data based on the user's input data while accurately identifying potential interpretation for the candidate login data or modifications thereof. For example, the multi-perspective evaluation system can assist a user in selecting candidate login data that is easy for the user to recall based on the candidate mnemonic data but difficult for a malicious party to guess (or otherwise circumvent) based on the candidate mnemonic data.

The following examples are provided to introduce certain embodiments of the present disclosure. In the example implementation, a multi-perspective login data evaluation computing system receives candidate login data, such as from a user computing system or a secured computing system. The multi-perspective evaluation system includes a trained mnemonic generation machine-learning model (also referred to herein as a “mnemonic generation model”) that is configured to perform assistive evaluation of the candidate login data. For example, the mnemonic generation model is configured to determine candidate login features that describe characteristics of the candidate login data. In addition, the mnemonic generation model is configured to identify one or more media data objects (e.g., images, audio, video) by comparing the candidate login features with media features of the media data objects. The mnemonic generation model generates candidate mnemonic data based on the identified media data objects or modifications to the identified media data objects. In some cases, the mnemonic generation model generates the candidate mnemonic data based on a combination of the identified media data objects that can provide memory assistance for the candidate login data. For instance, if the candidate login data includes a candidate password “H@mst3r” the mnemonic generation model identifies, based on the candidate login features for the candidate password, one or more media data objects related to hamsters, such as images of a hamster, an audio recording of a squeaking noise, or other suitable media data objects. The mnemonic generation model generates the candidate mnemonic data based a combination of some or all of the identified hamster images, audio recording, or other media data objects.

Continuing with this example, the multi-perspective evaluation system includes a trained mnemonic evaluation machine-learning model (also referred to herein as a “mnemonic evaluation model”) that is configured to perform adversarial evaluation of the candidate login data or the candidate mnemonic data. For example, the mnemonic evaluation model is configured to determine mnemonic guess features that describe characteristics of the candidate mnemonic data. In addition, the mnemonic evaluation model is configured to generate login guess data, such as login guess data objects indicating potential interpretations of the candidate mnemonic data, based on the mnemonic guess features. For instance, based on the example candidate mnemonic data that includes a combination of hamster images with an audio recording, the mnemonic evaluation model generates a login guess text string “Hamster” that indicates a potential interpretation of the candidate mnemonic data. In this example, the multi-perspective evaluation system restricts access to the candidate login data by the mnemonic evaluation model. In some cases, restricting access by the mnemonic evaluation model to the candidate login data can increase an accuracy of potential interpretations of the candidate mnemonic data, such as by emulating a situation in which a malicious actor has access to the candidate mnemonic data but does not know the candidate login data.

The example multi-perspective evaluation system provides one or more of the candidate mnemonic data or the login guess data to an additional computing system, such as the user computing system or the secured computing system from which the candidate login data is received. In addition, the multi-perspective evaluation system receives one or more data inputs indicating a relative security of the candidate login data or the candidate mnemonic data. For example, the multi-perspective evaluation system could receive alert data, e.g., from the secured computing system, indicating that the candidate mnemonic data or the candidate login data are relatively insecure, such as determining that the login guess text string “Hamster” and the candidate password “H@mst3r” are within a threshold similarity. In addition, the multi-perspective evaluation system could receive modification data or prompt data, e.g., from the user computing system, indicating a requested change to one or more of the candidate login data or the candidate mnemonic data. For example, the multi-perspective evaluation system could receive modification data indicating a requested change for the candidate password, such as modification data indicating a modified candidate password “H@mst3rsInPar!s.” In addition, the multi-perspective evaluation system could receive prompt data indicating a requested change for the candidate mnemonic data, such as prompt data indicating a request to include, in the candidate mnemonic data, an audio recording of a French-language song. In the multi-perspective evaluation system, the mnemonic generation model modifies the candidate mnemonic data based on the received modification data or prompt data. In addition, the mnemonic evaluation model modifies the login guess data based on the modified candidate mnemonic data, such as by generating a login guess text string “HamsterSong” that indicates a potential interpretation of the modified candidate mnemonic data. The multi-perspective evaluation system provides one or more of the modified candidate mnemonic data or the modified login guess data to an additional computing system. Based on additional data received from the additional computing system, such as approval data indicating a relatively high security of the modified candidate mnemonic data or the modified candidate login data, the multi-perspective evaluation system can generate, or otherwise provide, user profile data that includes the modified candidate mnemonic data or the modified candidate login data. In some cases, the described techniques for assistive evaluation and adversarial evaluation by the example multi-perspective evaluation system can increase security of the candidate login data. For example, the multi-perspective evaluation system generates the candidate mnemonic data that provides memory assistance for relatively complex login data (e.g., the modified candidate password “H@mst3rsInPar!s”), and can increase a likelihood that the user will feel comfortable selecting the relatively complex login data. In some cases, the candidate mnemonic data generated by the multi-perspective evaluation system can decrease a likelihood that the user might engage in high-risk behavior, such as writing the login data down on paper or saving an insecure (e.g., plaintext) computer file that includes the login data. In addition, the multi-perspective evaluation system generates login guess data that provides feedback about relative security of the candidate mnemonic data and candidate login data, such as by presenting potential interpretations, e.g., login guesses, of the candidate mnemonic data.

Certain embodiments described herein provide improved technical tools evaluating a relative security of login information or mnemonic data for login information. In addition, certain embodiments described herein provide improved technical tools for generating mnemonic data for login information. For example, a multi-perspective evaluation system can utilize particular rules to efficiently evaluate login data, such as a combination of assistive evaluation to generate mnemonic data for the login data and adversarial evaluation to generate or modify guess data for the mnemonic data. In some cases, application of these rules achieves one or more improved technological results, such as technological results that include identifying potentially insecure login data, such as a low-strength password, prior to generation of user profile data that utilizes the potentially insecure login data. For example, a multi-perspective evaluation system can provide, e.g., to a secured computing system or a user computing system, data indicating a relative security of login data or mnemonic data, such as real-time (e.g., period of time that is not noticeable by a user) data about guesses or other potential interpretations of the login data based on the mnemonic data. In some cases, application of these rules achieves one or more improved outcomes in a technological field, such as increasing user adoption of relatively high-strength login data, reducing low-strength login data in a technological field of computing security, or reducing high-risk user behavior for recalling login data (e.g., writing down login data). For example, a multi-perspective evaluation system can provide mnemonic data that improves security outcomes for a user, such as by assisting the user in generating secure login information or mnemonic data that is not readily interpretable by another party, e.g., a malicious actor. Additionally or alternatively, a multi-perspective evaluation system can generate mnemonic data to assist a user with remembering relatively complex login data, allowing the user to select password or other login data with higher strength while reducing uncertainty by the user, e.g., uncertainty about forgetting a relatively high-strength password.

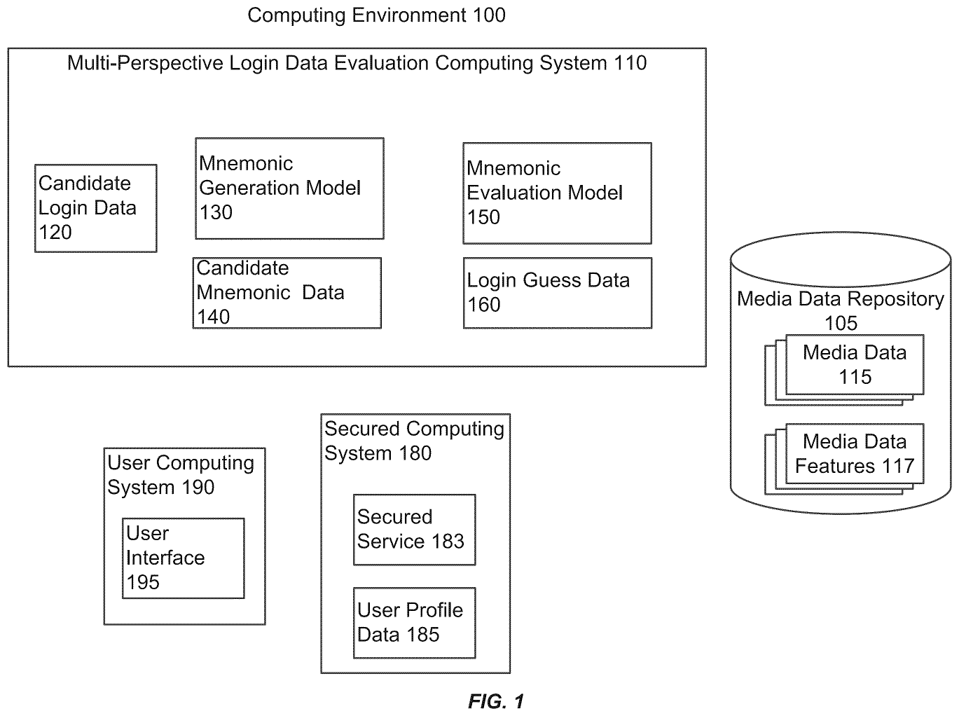

Referring now to the drawings, FIG. 1 is a diagram depicting an example of a computing environment 100, in which a multi-perspective login data evaluation computing system 110 (also referred to herein as the “multi-perspective evaluation system 110”) evaluates a relative security of generated mnemonic data for login data. The computing environment 100 can include one or more additional computing systems, such as one or more of a secured computing system 180 or a user computing system 190. In the computing environment 100, the multi-perspective evaluation system 110 is configured to exchange data with one or more additional computing systems, such as the secured computing system 180 or the user computing system 190, via one or more computing networks, such as a local or wide area network.

In the computing environment 100, the secured computing system 180 provides one or more secured services, such as a secured service 183. In addition, one or more authorized computing systems, such as the user computing system 190, access the secured service 183 via the secured computing system 180. In some cases, the secured computing system 180 includes, or otherwise accesses, authentication information for an authorized computing system, such as (at least) login data that is included in profile data associated with the authorized computing system. For example, the secured computing system 180 includes user profile data 185 that is associated with the user computing system 190. Based on the user profile data 185, the secured computing system 180 determines whether the user computing system 190 is authorized to access the secured service 183, such as by comparing login data received from the user computing system 190 with one or more portions of login data included in the user profile data 185. Examples of login data can include a username, a password, a security question/answer combination, biometric data (e.g., fingerprint, voice matching), multi-factor authentication (“MFA”) data, a seed phrase (e.g., a non-modifiable set of words associated with an app or a hardware device; also referred to herein as a “recovery phrase”), or other types of login data that can be modified by a user, such as upon submitting an update for user profile data.

In the computing environment 100, the user computing system 190 provides, to one or more of the secured computing system 180 or the multi-perspective evaluation system 110, a request to generate or modify the user profile data 185. For example, the user computing system 190 provides to the secured computing system 180 a request to create the user profile data 185, such as a request for a new user account for the secured service 183. Additionally or alternatively, the user computing system 190 provides to the secured computing system 180 a request to modify the user profile data 185, such as a request to update a password or other login data associated with an existing user account for the secured service 183. For example, the user computing system 190 generates request data based on one or more inputs received via a user interface 195 of the user computing system 190. In addition, the user computing system 190 provides the request data to, at least, the secured computing system 180. FIG. 1 depicts the user computing system 190, the secured computing system 180, and the multi-perspective evaluation system 110 as multiple computing systems, but other implementations are possible. For example, a secured computing system could include a multi-perspective evaluation system operating as a subsystem or other component of the example secured computing system. As another example, a user computing system could include a multi-perspective evaluation system operating as a subsystem or other component of the example user computing system, such as a locally-run computing program (e.g., “app”).

In FIG. 1, the multi-perspective evaluation system 110 receives or generates one or more portions of candidate login data 120 based on the request from the user computing system 190. For example, the multi-perspective evaluation system 110 can receive, from one or more of the user computing system 190 or the secured computing system 180, the request data for generating or modifying the user profile data 185. In some cases, the multi-perspective evaluation system 110 identifies, from the request data, one or more portions of the candidate login data 120, such as a candidate username and password combination that is provided by a user of the user computing system 190. Additionally or alternatively, the multi-perspective evaluation system 110 generates one or more portions of the candidate login data 120 based on the request data. For example, the multi-perspective evaluation system 110 could generate a candidate security question combination based on a portion of the request data, such as a request to suggest a security question associated with the user profile data 185.

In the computing environment 100, the multi-perspective evaluation system 110 includes multiple trained machine-learning models, including a mnemonic generation model 130 and a mnemonic evaluation model 150. Each of the mnemonic generation model 130 and the mnemonic evaluation model 150 is configured to implement a particular technique (or portion of a technique) for multi-perspective evaluation of login data, such as the candidate login data 120. In the multi-perspective evaluation system 110, the mnemonic generation model 130 is configured to provide assistive evaluation of the candidate login data 120. In addition, the mnemonic evaluation model 150 is configured to provide adversarial evaluation of the candidate login data 120. For example, the mnemonic generation model 130 is configured to generate one or more candidate mnemonic data objects, such as candidate mnemonic data 140, that can provide potential memory assistance for the user of the user computing system 190. In addition, the mnemonic evaluation model 150 is configured to generate interpretation data, such as login guess data 160, that describes one or more potential interpretations of the candidate mnemonic data objects generated by the mnemonic generation model 130. In some cases, the multi-perspective evaluation system 110 restricts access, by each of the mnemonic generation model 130 and the mnemonic evaluation model 150, to one or more data objects included in the multi-perspective evaluation system 110. For example, the multi-perspective evaluation system 110 could restrict access for the mnemonic generation model 130, such that the mnemonic generation model 130 is permitted to access the candidate login data 120 and is excluded from accessing the login guess data 160. In addition, the multi-perspective evaluation system 110 could restrict access for the mnemonic evaluation model 150, such that the mnemonic evaluation model 150 is excluded from accessing the candidate login data 120 and is permitted to access the login guess data 160.

In the multi-perspective evaluation system 110, the mnemonic generation model 130 generates the candidate mnemonic data 140 based on the candidate login data 120. In some cases, the candidate mnemonic data 140 includes one or more media data objects that are associated with the candidate login data 120. For example, the mnemonic generation model 130 determines one or more candidate features of the candidate login data 120, such as candidate features determined via one or more machine-learning models configured for analysis of text or other information included in the candidate login data 120. The determined candidate features of the candidate login data 120 could describe semantic or other characteristics of the candidate login data 120. As an example, if the candidate login data 120 includes a text string “H@mst3r” that is identified as a candidate password, the mnemonic generation model 130 could determine that the candidate password has a semantic candidate feature corresponding to hamsters. In this example, the candidate login data 120 includes a text string identified as a candidate password, but other implementations are possible, such as candidate login data that includes audio data, biometric data, or other types of candidate login data.

Based on the determined features of the candidate login data 120, the mnemonic generation model 130 identifies or generates one or more media data objects for inclusion in the candidate mnemonic data 140. For example, the mnemonic generation model 130 identifies one or more media data objects from media data 115 that is stored in a media data repository 105. Additionally or alternatively, the mnemonic generation model 130 generates one or more media data objects, such as a generated media data object that is based on a modification of one or more additional media data objects (e.g., from the media data repository 105). For example, the mnemonic generation model 130 identifies a subset of media data objects from the media data 115. In some cases, the mnemonic generation model 130 identifies the subset of media data objects based on a comparison of the candidate features of the candidate login data 120 with one or more additional features of the media data 115, such as media data features 117. Using the above example of “H@mst3r” as a portion of the candidate login data 120, the mnemonic generation model 130 could compare the semantic candidate feature corresponding to hamsters with one or more of the media data features 117. Based on the example comparison, the mnemonic generation model 130 could identify a first media data object having first media data features that are within a first threshold similarity to the example semantic candidate feature, such as a first image that depicts a group of hamsters.

Additionally or alternatively, the mnemonic generation model 130 determines a modification to one or more of the media data objects included in the subset, such as a modification that is based on the candidate features of the candidate login data 120. Continuing with the above example, the mnemonic generation model 130 could identify a second media data object having second media data features that are within a second threshold similarity (e.g., excluded from the first threshold similarity) to the example semantic candidate feature, such as a second image that depicts a guinea pig. Additionally or alternatively, the mnemonic generation model 130 determines a modification to the second media data object based on the example semantic candidate feature, such as an image modification that replaces the guinea pig image data with image data depicting a hamster. In some cases, the mnemonic generation model 130 determines multiple modifications to at least one media data object based on respective features of the candidate login data 120 or the subset of medic data objects. For example, the mnemonic generation model 130 could determine that the candidate password “H@mst3r” has an additional candidate feature corresponding to the “@” symbol. Based on the additional candidate feature, the mnemonic generation model 130 could determines an additional modification to the first or second image, such as a modification to depict a hamster holding an “@” symbol.

In FIG. 1, the media data features 117 are included in the media data repository 105. In some cases, the media data features 117 are determined based on additional analysis of the media data 115, such as analysis performed by one or more machine-learning models (e.g., which may exclude include the models 130 or 150). Additionally or alternatively, the media data features 117 are determined based on prior analysis (e.g., “offline analysis”) of the media data 115, such as analysis that is performed prior to use of the media data 115 or the media data features 117 by the mnemonic generation model 130. In FIG. 1, the media data repository 105 is depicted as being external to the multi-perspective evaluation system 110, e.g., accessible via one or more computing networks, but other implementations are possible. For example, a multi-perspective evaluation system could include one or more repositories of media data objects.

In the multi-perspective evaluation system 110, the mnemonic generation model 130 generates or modifies the candidate mnemonic data 140 to include media data that is based on a combination of the one or more media data objects identified or generated by the mnemonic generation model 130. For example, the candidate mnemonic data 140 can include media data that is a combination of one or more of the example first or second images, e.g., images of the hamster or group of hamsters. Additionally or alternatively, the candidate mnemonic data 140 includes media data from one or more additional media data objects, such as data objects that provide visual information (e.g., static images, animated images), audio (e.g., speech, music, sounds), video, haptic information (e.g., vibration, Braille data), or other types of media data. In some cases, the candidate mnemonic data 140 includes a combination of media data that is interpretable by a human, such as to provide memory assistance to the user of the user computing system 190. Continuing with the above example, the candidate mnemonic data 140 could include a combination of media data that is based on the modified first or second images, such as image data depicting a combination of the group of hamsters from the identified first image, the modified hamster (e.g., replacing the guinea pig) from the second image, and the modification to depict an “@” symbol held by one of the hamsters. In FIG. 1, this combination of media data in the candidate mnemonic data 140 could provide memory assistance to the user to recall the candidate password “H@mst3r” from the candidate login data 120.

In the multi-perspective evaluation system 110, the mnemonic evaluation model 150 generates the login guess data 160 based on the candidate mnemonic data 140. In some cases, the login guess data 160 includes one or more text strings that are generated by the mnemonic evaluation model 150. For example, the mnemonic evaluation model 150 determines one or more guess features of the candidate mnemonic data 140, such as guess features determined via one or more machine-learning models configured for analysis of media data included in the candidate mnemonic data 140. The determined guess features of the candidate mnemonic data 140 could describe semantic or other characteristics of the candidate mnemonic data 140. Using the above example of combined media data depicting multiple hamsters and an “@” symbol, the mnemonic evaluation model 150 could determine that the candidate mnemonic data 140 has guess features that include a semantic feature corresponding to hamsters and a text feature corresponding to special keyboard characters.

Based on one or more of the determined features of the candidate mnemonic data 140, the mnemonic evaluation model 150 generates or modifies the login guess data 160. In some cases, the generated or modified login guess data 160 includes one or more text strings that are generated by the mnemonic evaluation model 150. For example, the mnemonic evaluation model 150 determines that the candidate mnemonic data 140 has a combination of guess features that correspond to hamsters and special keyboard characters. In addition, the mnemonic evaluation model 150 generates one or more text strings, or other types of data objects indicating login guesses, that describe at least one interpretation of the candidate mnemonic data 140. For example, the mnemonic evaluation model 150 generates “@hamster” as a first text string and “H@msters” as a second text string. In some cases, the login guess data 160 includes additional data that describes one or more of the login guess data objects, such as descriptive data. For example, the mnemonic evaluation model 150 could modify the login guess data 160 to include descriptive data indicating that the text strings “@hamster” and “H@msters” are generated based on guess features from the candidate mnemonic data 140 that correspond to hamsters and special keyboard characters. In some cases, one or more of the models 130 or 150 can generate the candidate mnemonic data 140 or the login guess data 160 based on additional information, such as user historical data describing characteristics (e.g., social media activity, geographical region, personal information associated with the user profile data 185) of the user of the user computing system 190.

In the computing environment 100, the multi-perspective evaluation system 110 provides one or more of the candidate mnemonic data 140 or the login guess data 160 to at least one additional computing system, such as the user computing system 190 or the secured computing system 180. In addition, the user computing system 190 is configured to present, via one or more output devices of the user interface 195, at least a portion of data included in the candidate mnemonic data 140 or the login guess data 160. For example, the user computing system 190 presents the media data from the candidate mnemonic data 140, such as displaying an image that includes the combined media data of multiple hamsters and an “@” symbol. Additionally or alternatively, the user computing system 190 presents one or more login guess data objects from the login guess data 160, such as displaying the text strings “@hamster” and “H@msters” as potential interpretations of the combined media data. In some cases, the user computing system 190 is configured to display some or all of the descriptive data from the login guess data 160. For example, the user computing system 190 could display text describing that the text strings are generated based on characteristics (e.g., guess features) of hamsters and special keyboard characters present in the candidate mnemonic data 140. FIG. 1 describes the user computing system 190 as presenting image data or text data, but other implementations are possible. For example, if the candidate mnemonic data 140 includes audio data, haptic data, or other types of media data, the user computing system 190 can present the media data via a suitable output device. In addition, the user computing system 190 could be configured to present image or text data via an additional output device, such as modifying the data for presentation via a speaker, a Braille reader, or other type of output device.

In some implementations, the multi-perspective evaluation system 110 provides at least a portion of the login guess data 160 or the candidate mnemonic data 140 to the secured computing system 180. In some cases, the secured computing system 180 determines a similarity based on the login guess data 160, such as a similarity between the candidate password “H@mst3r” (e.g., based on the request to update the user profile data 185) and one or more of the text strings “@hamster” or “H@msters.” Additionally or alternatively, the secured computing system 180 could generate alert data based on the login guess data 160. For example, responsive to determining that the login guess data 160 includes at least one text string that is within a threshold similarity to a portion of the candidate login data 120, the secured computing system 180 could generate alert data indicating that the candidate login data 120 may be insecure, e.g., too easy to guess based on the candidate mnemonic data 140. In addition, the secured computing system 180 could provide the alert data to one or more of the user computing system 190 or the multi-perspective evaluation system 110.

In some cases, the multi-perspective evaluation system 110 receives one or more data inputs that indicate at least one modification to one or more of the candidate login data 120 or the candidate mnemonic data 140. Responsive to the one or more data inputs, the multi-perspective evaluation system 110 modifies one or more of the candidate login data 120, the candidate mnemonic data 140, or the login guess data 160. For example, the user computing system 190 can generate, based on an input to the user interface 195, modification data or prompt data indicating a modification to one or more of the candidate login data 120 or the candidate mnemonic data 140. In addition, the multi-perspective evaluation system 110 receives the modification data from the user computing system 190. Additionally or alternatively, the multi-perspective evaluation system 110 receives the alert data from the secured computing system 180. Example techniques to receive (or otherwise exchange) modification data, prompt data, or alert data can include a webform, a text-based communication channel (e.g., “chatbot”), an audio-based communication channel (e.g., home assistant audio device), an application programming interface (e.g., “API”), or other techniques to exchange descriptive information about the candidate login data 120 or the candidate mnemonic data 140.

In FIG. 1, the multi-perspective evaluation system 110 modifies one or more of the candidate login data 120, the candidate mnemonic data 140, or the login guess data 160 based on one or more of the modification data or the alert data. Responsive to the modification data from the user computing system 190 or the alert data from the secured computing system 180, the multi-perspective evaluation system 110 modifies one or more of the candidate login data 120, the candidate mnemonic data 140, or the login guess data 160. For example, the mnemonic generation model 130 determines that the modification data indicates a modification to the candidate login data 120, such as modifying the candidate password “H@mst3r” to “AH@mst3rInPari$” or another modified candidate password. Responsive to determining that the candidate login data 120 is modified, the mnemonic generation model 130 modifies the candidate mnemonic data 140, such as by determining one or more candidate features of the modified candidate login data 120 and identifying or generating additional media data based on the modified candidate features.

Additionally or alternatively, the mnemonic generation model 130 determines that the modification data indicates a modification to the candidate mnemonic data 140, such as prompt data indicating a requested change to the media data included in the candidate mnemonic data 140. Responsive to determining that the modification data includes the prompt data, the mnemonic generation model 130 modifies the candidate mnemonic data 140 based on the prompt data. For example, the mnemonic generation model 130 determines that the prompt data describes a requested change to the candidate mnemonic data 140, such as text data (e.g., entered via the user interface 195) that describes removing the “@” symbol from the candidate mnemonic data 140 and depicting one of the hamsters wearing a hat. Based on the prompt data, the mnemonic generation model 130 modifies the candidate mnemonic data 140. For example, the mnemonic generation model 130 determines features of the prompt data, such as text features or semantic features that describe characteristics of the prompt data. In some cases, the mnemonic generation model 130 selects one or more additional media data objects from the media data 115 based on the prompt data features, such as selecting an additional image of a hat. Additionally or alternatively, the mnemonic generation model 130 modifies the candidate mnemonic data 140 based on the prompt data features, such as modifying image data to remove the “@” symbol or to include additional media data from at least one additional media objects, such as the example image of the hat. FIG. 1 describes the modification data as indicating modifications to the candidate login data 120 and the candidate mnemonic data 140, but other implementations are possible. For example, the multi-perspective evaluation system 110 could receive modification data that indicates a change to the candidate mnemonic data 140 without indicating a change to the candidate login data 120.

In some cases, the mnemonic generation model 130 modifies the candidate mnemonic data 140 in response to the alert data from the secured computing system 180. For example, the mnemonic generation model 130 determines that the alert data indicates that the candidate login data 120 is within a threshold similarity to the login guess data 160 (e.g., relatively insecure). Responsive to determining that the candidate login data 120 is within the threshold similarity, the mnemonic generation model 130 modifies the candidate mnemonic data 140, such as by identifying or generating additional media data based on features of the candidate login data 120 (or modified candidate login data 120).

In the computing environment 100, the mnemonic evaluation model 150 determines that the candidate mnemonic data 140 is modified, e.g., by the mnemonic generation model 130. Responsive to determining that the candidate mnemonic data 140 is modified, the mnemonic evaluation model 150 modifies the login guess data 160. For example, the mnemonic evaluation model 150 determines one or more additional guess features of the modified candidate mnemonic data 140. Based on the additional guess features, the mnemonic evaluation model 150 generates one or more additional login guess data objects, such as at least one additional text string describing interpretations of the modified candidate mnemonic data 140. For example, based on additional guess features describing the modified media data that depicts a hamster wearing a hat, the mnemonic evaluation model 150 generates “HamsterHat” as an additional text string.

In the computing environment 100, the multi-perspective evaluation system 110 provides one or more of the modified candidate mnemonic data 140 or the modified login guess data 160 to at least one additional computing system, such as the user computing system 190 or the secured computing system 180. In addition, the user computing system 190 is configured to present at least a portion of data included in the modified candidate mnemonic data 140 or the modified login guess data 160, such as presenting the combined media data depicting a hamster wearing a hat and the login guess data object of “HamsterHat” as a potential interpretation of the combined media data. Additionally or alternatively, the secured computing system 180 determines an additional similarity based on the modified login guess data 160, such as an additional similarity between the candidate password “H@mst3r” and the additional text string “HamsterHat.”

In FIG. 1, the multi-perspective evaluation system 110 receives approval data from one or more additional computing system, such as approval data indicating a relationship among the candidate login data 120, the candidate mnemonic data 140, or the login guess data 160 (or modified data 120, 140, or 160). For example, the multi-perspective evaluation system 110 could receive the approval data via a chatbot, an API, or via another technique to exchange descriptive information about the candidate login data 120 or the candidate mnemonic data 140. In some cases, the approval data indicates one or more of a security relationship or an assistance relationship among two or more of the candidate login data 120, the candidate mnemonic data 140, and the login guess data 160. For example, the multi-perspective evaluation system 110 receives, from the user computing system 190, first approval data indicating an assistance relationship between the candidate login data 120 and the candidate mnemonic data 140. An example of an assistance relationship could include approval data indicating relative memory assistance of the candidate mnemonic data 140 in relation to the candidate login data 120, such as an assistance relationship indicating that that the candidate mnemonic data 140 provides sufficient memory assistance (e.g., exceeds an assistance threshold) for the candidate login data 120. Additionally or alternatively, the multi-perspective evaluation system 110 receives, from the secured computing system 180, second approval data indicating a security relationship among two or more of the candidate login data 120, the candidate mnemonic data 140, and the login guess data 160. An example of a security relationship could include approval data indicating a relative security of the candidate login data 120 or the candidate mnemonic data 140 in comparison with the login guess data 160, such as a security relationship indicating that the login guess data 160 is relatively dissimilar (e.g., fails to exceed a similarity threshold) from the candidate password or other login data associated with candidate login data 120 or the candidate mnemonic data 140. In some cases, responsive to receiving one or more of the first or second approval data, the multi-perspective evaluation system 110 provides approved login data to at least one additional computing system. In addition, the approved login data could configure the additional computing system to perform a modification to a user profile, login data, or other types of data. For example, based on data from the multi-perspective evaluation system 110 indicating that the candidate login data 120 or the candidate mnemonic data 140 is approved, the secured computing system 180 updates the user profile data 185 to include one or more of the candidate login data 120 or the candidate mnemonic data 140.

In some cases, generating or modifying the candidate mnemonic data 140 by the multi-perspective evaluation system 110 can improve one or more of security for the candidate login data 120 or memory assistance to the user of the user computing system 190. For example, the candidate mnemonic data 140 can include a combination of media data that provides, to the user of the user computing system 190, a reminder of one or more portions of login data that are included in the user profile data 185. In addition, the candidate mnemonic data 140 can provide assistance to the user for remembering a password or other login data, including a password of relatively high length or complexity as compared to passwords that are previously used by the user. Additionally or alternatively, the candidate mnemonic data 140 can improve security of one or more portions of login data that are included in the user profile data 185, such as by increasing a likelihood of the user selecting relatively strong passwords, such as passwords of increased length or complexity. In some cases, a user who utilizes candidate mnemonic data generated by a multi-perspective evaluation system, such as the multi-perspective evaluation system 110, may have improved confidence in selecting login information such as passwords. In addition, a user who utilizes candidate mnemonic data generated by a multi-perspective evaluation system may be more likely to use relatively strong login information, less likely to reuse login information across multiple computing systems, or have other improvements in security for the user's login information, increasing a security of one or more secured services or secured computing systems.

In some implementations, a multi-perspective login data evaluation computing system includes multiple trained machine learning models that are configured to exchange data within the multi-perspective evaluation system. In addition, each particular trained machine learning model is configured to generate one or more data objects, such as candidate mnemonic data or login guess data, that are based on analysis of inputs to the particular trained machine learning model. In some cases, the multi-perspective evaluation system controls access of each particular trained machine learning model to one or more particular inputs. For example, each particular trained machine learning model is configured to generate at least one feature set for a particular input data object. The feature set can indicate characteristics of the particular input data object that are determined by the particular trained machine learning model. In addition, the particular trained machine learning model is restricted, e.g., by the multi-perspective evaluation system, from accessing additional input data objects or feature sets associated with an additional trained machine learning model in the multi-perspective evaluation system. In some cases, controlling data access of the trained machine learning models improves security of candidate mnemonic data that is generated by the multi-perspective evaluation system, such as by providing an accurate evaluation of the relative security of the candidate mnemonic data.

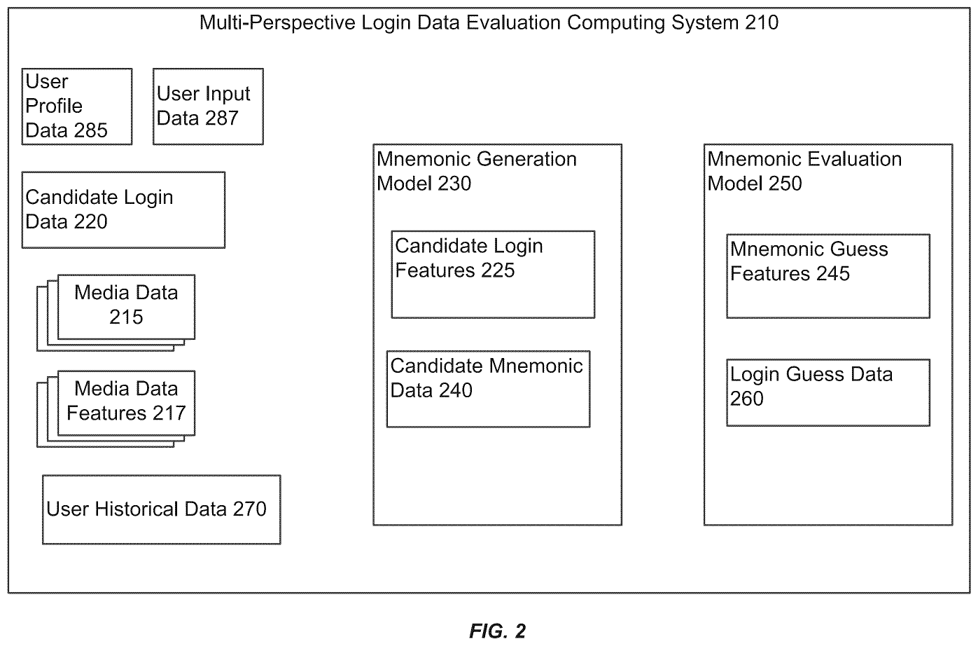

FIG. 2 depicts an example of a multi-perspective login data evaluation computing system 210 (also referred to herein as the “multi-perspective evaluation system 210”) configured to control data access among multiple trained machine learning models. In some cases, the multi-perspective evaluation system 210 is configured to generate one or more of candidate mnemonic data 240 or login guess data 260. In addition, the multi-perspective evaluation system 210 is configured to exchange data, such as the candidate mnemonic data 240 or the login guess data 260, with one or more additional computing systems, such as the secured computing system 180 or the user computing system 190 described in regard to FIG. 1.

In FIG. 2, the multi-perspective evaluation system 210 includes multiple trained machine learning models, such as a mnemonic generation model 230 and a mnemonic evaluation model 250. In addition, the multi-perspective evaluation system 210 controls data access by one or more of the mnemonic generation model 230 or the mnemonic evaluation model 250. For example, the multi-perspective evaluation system 210 receives or generates candidate login data 220 based on data received from an additional computing system, such as from the user computing system 190 or the secured computing system 180. In some cases, the candidate login data 220 includes one or more portions of login data, such as candidate data for a username, a password, a security question/answer combination, a type of biometric data, a seed phrase, a type of MFA, or other types of login data. In some cases, the candidate login data 220 includes one or more portions of prompt data, such as a prompt indicating a requested characteristic for or change to the candidate mnemonic data 240. In FIG. 2, the candidate login data 220 is associated with a user profile for a secured service or a secured computing system, such as user profile data 285. In some cases, the user profile data 285 is generated or modified based on the candidate login data 220 (or a modification to the candidate login data 220). For example, responsive to receiving, such as from a user computing system, approval data indicating a relative security of the candidate mnemonic data 240 (or modification to the candidate mnemonic data 240), the multi-perspective evaluation system 210 can generate or modify the user profile data 285 to include one or more portions of the candidate login data 220. FIG. 2 depicts the user profile data 285 as included in the multi-perspective evaluation system 210, but other implementations are possible, such as user profile data that is generated or modified by an additional computing system, based on data received from a multi-perspective evaluation system.

In some implementations, the multi-perspective evaluation system 210 controls access to the candidate login data 220 by one or more of the mnemonic generation model 230 or the mnemonic evaluation model 250. For example, the multi-perspective evaluation system 210 denies or otherwise restricts access to the candidate login data 220 by the mnemonic evaluation model 250, such that the mnemonic evaluation model 250 is unable to access some or all of the portions of the candidate login data 220. In addition, the multi-perspective evaluation system 210 could permit access to the candidate login data 220 by the mnemonic generation model 230. Based on the permitted access, the mnemonic generation model 230 generates at least one feature set, such as a set of candidate login features 225, that describes characteristics of the candidate login data 220 (also referred to herein as “candidate features”). Examples of candidate features for the candidate login data 220 can include text features, such as for a password, a username, a security question/answer combination, prompt data, or other types of text data included in the candidate login data 220. Additional examples of candidate features for the candidate login data 220 can include media features, such as for a facial image, a fingerprint image, a voice recording, or other types of media data included in the candidate login data 220.

In the multi-perspective evaluation system 210, the mnemonic generation model 230 performs assistive evaluation of the candidate login features 225 (or a combination of the candidate login features 225 with one or more additional feature sets). In some cases, the assistive evaluation by the mnemonic generation model 230 identifies characteristics of one or more media data objects that can provide memory assistance for characteristics of the candidate login features 225. For example, the mnemonic generation model 230 compares one or more of the candidate login features 225 to one or more media data features 217 that are associated with media data 215. In some cases, the multi-perspective evaluation system 210 receives or otherwise accesses one or more of the media data 215 or the media data features 217 from a data repository, such as the media data repository 105 described in regard to FIG. 1. In the multi-perspective evaluation system 210, the mnemonic generation model 230 identifies a subset of media data objects from the media data 215 based on a comparison of the candidate login features 225 with one or more of the media data features 217. In some cases, the multi-perspective evaluation system 210 denies or otherwise restricts access by the mnemonic evaluation model 250 to one or more of the media data 215 or the media data features 217, such that the mnemonic evaluation model 250 is unable to access some or all of the media data 215 or the media data features 217.

In some implementations, the mnemonic generation model 230 identifies a subset of media data objects from the media data 215 based on a combination of the candidate login features 225 with additional features describing characteristics of one or more additional data objects. As an example, the mnemonic generation model 230 could access user historical data 270 that is included in or otherwise accessible by the multi-perspective evaluation system 210. The user historical data 270 could include or indicate data that describes characteristics of a user associated with the user profile data 285, such as social media activity, an IP address for a user computing system, user data (e.g., an online photo gallery) included in the secured service associated with the user profile data 285, or other types of public data or private data that are associated with the user of the user profile data 285. In some cases, the user historical data 270 could include or indicate derived data that describes characteristics of a group of users who share a characteristic with a user associated with the user profile data 285. Examples of derived data in the user historical data 270 could include regional characteristics (e.g., associated with multiple IP addresses for a group of users), interest characteristics (e.g., associated with a hobby associated with a group of users), or other types of characteristics associated with a group of users.

In FIG. 2, the mnemonic generation model 230 generates a first additional feature set describing at least a portion of the user historical data 270. Based on a combination of the candidate login features 225 with the first additional feature set, the mnemonic generation model 230 identifies at least one media data object for inclusion in the identified subset of media data objects. As an additional example, the candidate login features 225 could include prompt data indicating a request to include, in the candidate mnemonic data 240, a particular video located at a particular webpage. In this additional example, the mnemonic generation model 230 generates a second additional feature set of the particular video and, based on a combination of the candidate login features 225 with the second additional feature set, identifies a portion of the particular video (or other media data, such as from the media data 215) for inclusion in the identified subset of media data objects. In some cases, the multi-perspective evaluation system 210 denies or otherwise restricts access by the mnemonic evaluation model 250 to the additional features generated by the mnemonic generation model 230 for the one or more additional data objects. In addition, the multi-perspective evaluation system 210 denies or otherwise restricts access by the mnemonic evaluation model 250 to at least a portion of the user historical data 270. For example, if the user historical data 270 includes a first portion of public data (e.g., public social media activity, an IP address) and a second portion of private data (e.g., an online photo gallery that is protected by the secured service), the multi-perspective evaluation system 210 denies the mnemonic evaluation model 250 access to the second portion of private data.

In the multi-perspective evaluation system 210, the mnemonic generation model 230 generates or modifies the candidate mnemonic data 240 based on the identified subset of media data objects. In some cases, the candidate mnemonic data 240 includes one or more of the identified media data objects, portions of the identified media data objects, modifications to the identified media data objects, or another suitable combination of media data based on the identified media data objects. In addition, the mnemonic generation model 230 generates or modifies the candidate mnemonic data 240 to include media data with characteristics that can provide memory assistance for characteristics of the candidate login features 225. In some cases, the candidate mnemonic data 240 includes first media data that can provide memory assistance for characteristics associated with a first portion of the candidate login data 220 that can be modified, second media data that can provide memory assistance for characteristics associated with a second portion of the candidate login data 220 that cannot be modified, or a combination of media data that can provide memory assistance for modifiable and non-modifiable portions of the candidate login data 220. For example, if the candidate login data 220 includes a candidate password that could be modified, e.g., by a user associated with the user profile data 285, the candidate mnemonic data 240 can include first media data that can provide memory assistance for the candidate password. Continuing with this example, if the candidate login data 220 includes a seed phrase that is non-modifiable, such as a string of twenty-four words associated with a particular hardware device, the candidate mnemonic data 240 can include second media data that can provide memory assistance for the seed phrase, such as respective media data portions providing assistance for each of the twenty-four words.

In some implementations, the multi-perspective evaluation system 210 permits access to the candidate mnemonic data 240 by the mnemonic evaluation model 250. Based on the permitted access, the mnemonic evaluation model 250 generates at least one feature set, such as a set of mnemonic guess features 245, that describes characteristics of the candidate mnemonic data 240 (also referred to herein as “guess features”). Examples of guess features for the candidate mnemonic data 240 can include media features, such as for images, audio, video, haptic data (e.g., vibration), or other types of media data included in the candidate mnemonic data 240. Additional examples of guess features for the candidate mnemonic data 240 can include semantic features (e.g., indicating a semantic or contextual characteristics of the candidate mnemonic data 240), text features (e.g., describing guessed interpretations of the candidate mnemonic data 240), or other types of features describing the candidate mnemonic data 240. In some cases, candidate features, media data features, guess features, prompt data features, or other features described herein can include one or more data types or data objects that are not intended for human interpretation, e.g., numeric vectors.

In the multi-perspective evaluation system 210, the mnemonic evaluation model 250 performs adversarial evaluation of the mnemonic guess features 245 (or a combination of the mnemonic guess features 245 with one or more additional feature sets). In some cases, adversarial evaluation by the mnemonic evaluation model 250 identifies characteristics of the candidate mnemonic data 240 that can indicate potential interpretations, such as interpretations to guess login data for which the candidate mnemonic data 240 provides memory assistance. For example, the mnemonic evaluation model 250 determines one or more of the mnemonic guess features 245 that are associated with (e.g., via a training process) a particular type of login data, such as a password. In addition, the mnemonic evaluation model 250 generates one or more text strings or other types of login guess data objects that are potential interpretations of the mnemonic guess features 245.

In the multi-perspective evaluation system 210, the mnemonic evaluation model 250 generates or modifies the login guess data 260 based on the mnemonic guess features 245. In some cases, the login guess data 260 includes the text strings or other types of login guess data objects that are potential interpretations of the mnemonic guess features 245. Additionally or alternatively, the login guess data 260 includes additional data, such as descriptive data for one or more of the text strings or login guess data objects. For example, the mnemonic evaluation model 250 can generate or modify the login guess data 260 to include descriptive data that describes a guess source, e.g., a combination of characteristics from the mnemonic guess features 245 that suggested the potential interpretation provided by the text strings or login guess data objects.

In some implementations, the mnemonic evaluation model 250 generates or modifies the login guess data 260 based on a combination of the mnemonic guess features 245 with additional features describing characteristics of one or more additional data objects. As an example, the mnemonic evaluation model 250 could access data describing login criteria associated with the user profile data 285. For instance, the accessed data could describe publicly accessible criteria for login data (e.g., a minimum username length criteria, a minimum password complexity criteria) for a secured computing system or secured service that is associated with the user profile data 285. In this example, the mnemonic evaluation model 250 generates a first additional feature set describing the publicly accessible criteria. Based on a combination of the mnemonic guess features 245 with the first additional feature set, the mnemonic evaluation model 250 generates at least one text string or other login guess data object that provides a potential interpretation of the mnemonic guess features 245 in combination with the first additional feature set. As an additional example, the mnemonic evaluation model 250 could access at least a portion, e.g., a publicly accessible portion, of the user historical data 270. In this additional example, the mnemonic evaluation model 250 generates a second additional feature set describing at least a portion of the user historical data 270. For instance, the second additional feature set could describe characteristics of publicly accessible social media posts by the user of the user profile data 285. Based on a combination of the mnemonic guess features 245 with the second additional feature set, the mnemonic evaluation model 250 generates at least one text string or other login guess data object that provides a potential interpretation of the mnemonic guess features 245 in combination with the second additional feature set. In some cases, the mnemonic evaluation model 250 includes in the login guess data 260 descriptive data that describes the combination of the mnemonic guess features 245 with the first or second additional feature set. For instance, if the candidate mnemonic data 240 includes an image of a hamster and the mnemonic evaluation model 250 accesses a public social media post that describes the user's pet hamster named Ricky, the mnemonic evaluation model 250 could include in the login guess data 260 a text string “R!cky” and descriptive data that indicates the text string is based on a potential interpretation of the image in combination with the public social media post.

In FIG. 2, the multi-perspective evaluation system 210 provides one or more of the candidate mnemonic data 240 or the login guess data 260 to one or more additional computing systems, such as a user computing system or a secured computing system associated with the user profile data 285. In addition, the multi-perspective evaluation system 210 receives at least one data input, such as user input data 287, that indicates one or more of the candidate mnemonic data 240 or the candidate login data 220. In FIG. 2, the user input data 287 is received from a user computing system associated with the user profile data 285, but other implementations are possible, such as a data input that is received by the multi-perspective evaluation system 210 from a secured computing system associated with the user profile data 285.

The multi-perspective evaluation system 210 determines that the user input data 287 includes one or more of modification data or approval data. In some cases, the multi-perspective evaluation system 210 identifies that the user input data 287 includes modification data indicating one or more of the candidate login data 220 or the candidate mnemonic data 240. Responsive to identifying the modification data, the mnemonic generation model 230 performs an additional assistive evaluation of the candidate login features 225 (or a combination of the candidate login features 225 with one or more additional feature sets) based on the modification data. For example, if the modification data changes a candidate password included in the candidate login data 220, the mnemonic generation model 230 modifies the candidate login features 225 to include at least one feature of the changed candidate password. Additionally or alternatively, if the modification data includes prompt data indicating a change to the candidate mnemonic data 240, the mnemonic generation model 230 identifies, based on the prompt data, one or more of an additional media data object (e.g., from the media data 215) or a modification to media data included in the candidate mnemonic data 240. In addition, responsive to determining that the candidate mnemonic data 240 is modified, the mnemonic evaluation model 250 performs an additional adversarial evaluation of the mnemonic guess features 245 (or a combination of the mnemonic guess features 245 with one or more additional feature sets). For example, the mnemonic evaluation model 250 modifies the mnemonic guess features 245 to include one or more additional guess features of the modified candidate mnemonic data 240. In addition, the mnemonic evaluation model 250 modifies the login guess data 260 based on the modified mnemonic guess features 245.

In some cases, the multi-perspective evaluation system 210 identifies that the user input data 287 includes approval data indicating a relationship among one or more of the candidate login data 220, the candidate mnemonic data 240, or the login guess data 260. For example, the multi-perspective evaluation system 210 determines that the approval data describes a security relationship indicating that login guess data 260 is dissimilar (e.g., does not exceed a similarity threshold) from the candidate login data 220. Additionally or alternatively, the multi-perspective evaluation system 210 determines that the approval data describes an assistance relationship indicating relative memory assistance of the candidate mnemonic data 240 for the candidate login data 220. Responsive to identifying the approval data, the multi-perspective evaluation system 210 modifies the user profile data 285 to include one or more of the candidate login data 220 or the candidate mnemonic data 240. Additionally or alternatively, the multi-perspective evaluation system 210 provides the user profile data 285 to one or more additional computing systems, such as a user computing system or a secured computing system associated with the user profile data 285.

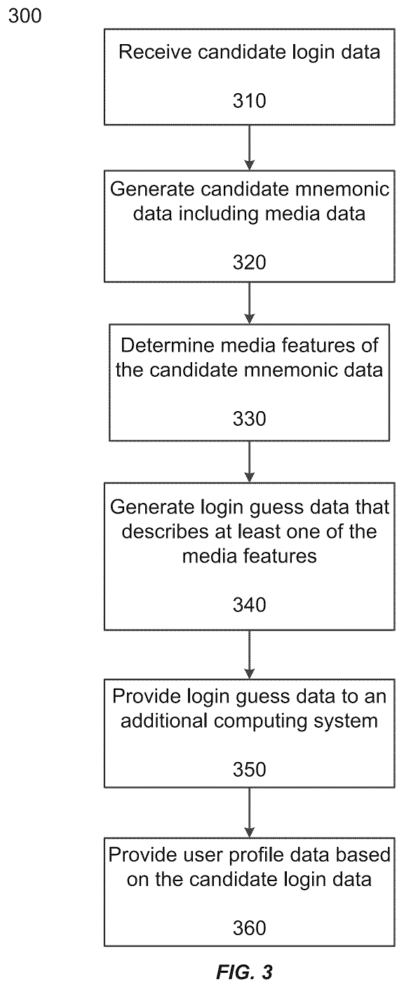

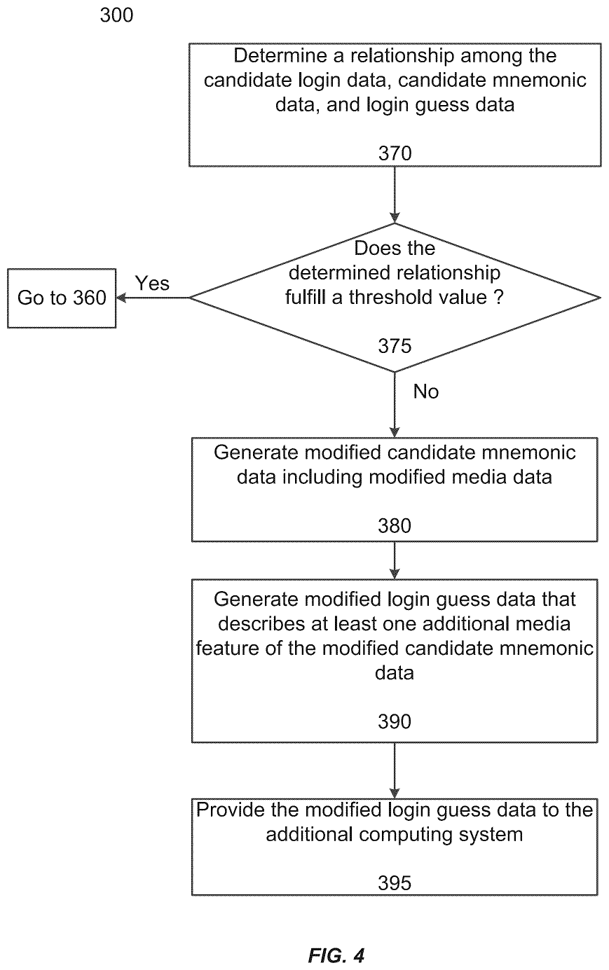

FIGS. 3 and 4 are flow charts depicting an example of a process 300 for generating one or more data objects, such as candidate mnemonic data or login guess data, for multi-perspective evaluation of login data, such as assistive evaluation or adversarial evaluation. In some embodiments, such as described in regards to FIGS. 1-2, a computing device executing a multi-perspective login data evaluation computing system implements operations described in FIG. 3 or 4, by executing suitable program code. For illustrative purposes, the process 300 is described with reference to the examples depicted in FIGS. 1-2. Other implementations, however, are possible.

At block 310, the process 300 involves receiving candidate login data by a multi-perspective evaluation system. For example, the multi-perspective evaluation system receives the candidate login data from one or more additional computing systems. In some cases, the candidate login data is associated with a request to access a secured computing system or a secured service, such as a request to generate or modify user profile data for the secured computing system. Additionally or alternatively, the candidate login data includes one or more portions of candidate data, such as a candidate username, candidate password, or other suitable types of candidate login information. For example, the multi-perspective evaluation system 110 receives the candidate login data 120 from one or more of the user computing system 190 or the secured computing system 180. In addition, the candidate login data 120 is associated with the user profile data 185.

At block 320, the process 300 involves generating, by the multi-perspective evaluation system, one or more portions of candidate mnemonic data based on the candidate login data. In addition, the candidate mnemonic data includes media data, or a combination of media data, that is associated with the candidate login data. In some cases, a trained mnemonic generation model in the multi-perspective evaluation system determines a set of candidate features of the candidate login data. In addition, the mnemonic generation model identifies one or more media data objects based on a comparison of the candidate features with media features of a set of media data. For example, the mnemonic generation model 230 determines the candidate login features 225 that describe the candidate login data 220. In addition, the mnemonic generation model 230 identifies one or more media data object from the media data 214, based on a comparison of the candidate login features 225 with the media data features 217. In some cases, the mnemonic generation model is configured to generate the candidate mnemonic data based on a combination of the candidate features with one or more sets of additional features. For example, the mnemonic generation model 230 can generate the candidate mnemonic data 240 based on a combination of the candidate login features 225 with additional features of at least a portion of the user historical data 270.

In some cases, the candidate mnemonic data can provide memory assistance for the candidate login data. Additionally or alternatively, the candidate mnemonic data includes a combination of media data that can provide memory assistance for modifiable and non-modifiable portions of the candidate login data. For example, the candidate mnemonic data can include first media data that provides memory assistance for a modifiable portion of the candidate login data, such as a candidate password, candidate username, candidate security question/answer combination, or other types of modifiable login data. Additionally or alternatively, the candidate mnemonic data can include second media data that provides memory assistance for a non-modifiable portion of the candidate login data, such as biometric data, a seed phrase, or other types of non-modifiable login data.

At block 330, the process 300 involves determining, by the multi-perspective evaluation system, one or more guess features of the candidate mnemonic data, such as guess features determined by a trained mnemonic evaluation model included in the multi-perspective evaluation system. In some cases, the multi-perspective evaluation system limits data access of the mnemonic evaluation model, such as permitting access to the candidate mnemonic data by the mnemonic evaluation model and restricting access to the candidate login data by the mnemonic evaluation model. In addition, the guess features include media features of the candidate mnemonic data, such as media features describing the combination of media data included in the candidate mnemonic data. For example, the mnemonic evaluation model 250 determines the mnemonic guess features 245 that describe the candidate mnemonic data 240, including one or more media features that describe characteristics of the combination of media data objects in the candidate mnemonic data 240.

At block 340, the process 300 involves generating, by the multi-perspective evaluation system, login guess data that is based on the one or more guess features. In some cases, the mnemonic evaluation model included in the multi-perspective evaluation system generates the login guess data. In addition, the login guess data includes one or more login guess data objects, such as at least one text string, that describe potential interpretations of the candidate mnemonic data or the guess features. Additionally or alternatively, the login guess data includes descriptive data describing a guess source of the one or more login guess data objects, such as descriptive data indicating a combination of the guess features that suggested the potential interpretation provided by a particular one of the login guess data objects. For example, the mnemonic evaluation model 250 generates, based on the mnemonic guess features 245, the login guess data 260. In addition, the login guess data 260 includes at least one login guess data object that indicates a potential interpretation of the candidate mnemonic data 240. In some cases, the mnemonic evaluation model is configured to generate the login guess data based on a combination of the guess features with one or more sets of additional features. For example, the mnemonic evaluation model 250 can generate the login guess data 260 based on a combination of the mnemonic guess features 245 with additional features of at least a portion of the user historical data 270.

At block 350, the process 300 involves providing, by the multi-perspective evaluation system, one or more of the login guess data or the candidate mnemonic data to one or more additional computing systems. In some cases, the multi-perspective evaluation system provides the login guess data or the candidate mnemonic data to an additional computing system from which the candidate login data is received. For example, the multi-perspective evaluation system 110 provides one or more of the login guess data 160 or the candidate mnemonic data 140 to one or more of the user computing system 190 or the secured computing system 180. In some cases, the additional computing system is configured to present the login guess data or the candidate mnemonic data, such as the user computing system 190 being configured to present the candidate mnemonic data 140 or the login guess data 160 via the user interface 195. Additionally or alternatively, the additional computing system is configured to determine at least one relationship based on the login guess data or the candidate mnemonic data, such as the secured computing system 180 being configured to determine a similarity among (at least) the login guess data 160 and the candidate password from the candidate login data 120.

At block 360, the process 300 involves providing, by the multi-perspective evaluation system, user profile data that is based on the candidate login data. In some cases, the multi-perspective evaluation system generates or modifies the user profile data based on one or more relationships that are identified among the candidate login data, the candidate mnemonic data, or the login guess data. For example, the multi-perspective evaluation system could receive, from one or more additional computing systems, approval data indicating a relationship among the candidate login data, the candidate mnemonic data, or the login guess data, such as an assistance relationship or a security relationship. Additionally or alternatively, the multi-perspective evaluation system could determine a relationship among the candidate login data, the candidate mnemonic data, or the login guess data, such as determining a similarity between one or more portions of the candidate login data and one or more login guess data objects in the login guess data. In some cases, responsive to determining the relationship, the multi-perspective evaluation system provides the user profile data to one or more additional computing systems. For example, responsive to receiving approval data from one or more of the user computing system 190 or the secured computing system 180, the multi-perspective evaluation system 110 provides approved login data to (at least) the secured computing system 180 for the user profile data 185. Additionally or alternatively, the multi-perspective evaluation system 210 generates or modifies the user profile data 285 and provides the user profile data 285 to an additional computing system.

In some cases, the multi-perspective evaluation system described in regard to the process 300 determines a modification to one or more of the candidate login data, the candidate mnemonic data, or the login guess data. FIG. 4 is a flow chart depicting an example portion of the process 300 for modifying one or more data objects, such as the candidate mnemonic data or the login guess data. In some cases, FIG. 4 describes an example portion of the process 300 for an additional assistive evaluation or additional adversarial evaluation of login data.

At block 370, the process 300 involves determining, by the multi-perspective evaluation system, at least one relationship among one or more of the candidate login data, the candidate mnemonic data, or the login guess data. In some cases, the multi-perspective evaluation system receives alert data indicating a security relationship among the candidate login data, the candidate mnemonic data, or the login guess data. For example, the multi-perspective evaluation system 110 receives, from the secured computing system 180, alert data indicating a relative insecurity of the candidate login data 120, based on the login guess data 160 being within a threshold similarity to the candidate login data 120. Additionally or alternatively, the multi-perspective evaluation system receives modification data or prompt data indicating an assistance relationship among the candidate login data, the candidate mnemonic data, or the login guess data, such as modification data indicating a modification of the candidate login data or the candidate mnemonic data. For example, the multi-perspective evaluation system 110 receives, from the user computing system 190, modification data indicating a modification to one or more of the candidate login data 120 or the candidate mnemonic data 140. In some cases, the multi-perspective evaluation system determines one or more of the relationships, such as by performing a comparison (or other analysis) among one or more of the candidate login data, the candidate mnemonic data, the login guess data, or features (e.g., guess features, candidate features) of the data objects.

At block 375, the process 300 involves determining, by the multi-perspective evaluation system, if the one or more relationships fulfill respective threshold values. In addition, the one or more relationships can include one or more of a security relationship or an assistance relationship. In some cases, the multi-perspective evaluation system determines whether a relationship is fulfilled based on one or more of approval data, alert data, modification data, prompt data, a comparison performed by the multi-perspective evaluation system, or other suitable input data. For example, based on alert data received from the secured computing system 180, the multi-perspective evaluation system 110 determines that one or more of the candidate login data 120 or the candidate mnemonic data 140 has a relatively low security, e.g., the candidate login data 120 exceeds a threshold similarity value with respect to the login guess data 160. Additionally or alternatively, based on the modification data received from the user computing system 190, the multi-perspective evaluation system 110 determines that the candidate mnemonic data 140 provides relatively poor memory assistance for the candidate login data 120, e.g., the candidate mnemonic data 140 fails to exceed a threshold assistance value with respect to the candidate login data 120.

If operations related to block 375 determine that the one or more relationships are fulfilled, the process 300 proceeds to another block, such as block 360. For example, if the multi-perspective evaluation system determines that a security relationship is fulfilled (e.g., the login guess data is dissimilar from the candidate login data) and that an assistance relationship is fulfilled (e.g., the candidate mnemonic data provides sufficient memory assistance for the candidate login data), the multi-perspective evaluation system may proceed to operations related to block 360. For example, the multi-perspective evaluation system 110 could receive approval data from one or more of the secured computing system 180 or the user computing system 190.

If operations related to block 375 determine that the one or more relationships are not fulfilled, the process 300 proceeds to another block, such as block 380. For example, if the multi-perspective evaluation system determines that a security relationship is not fulfilled (e.g., the login guess data is too similar to the candidate login data) or that an assistance relationship is not fulfilled (e.g., the candidate mnemonic data provides insufficient memory assistance for the candidate login data), the multi-perspective evaluation system may proceed to operations related to block 380. For example, the multi-perspective evaluation system 110 could receive one or more of alert data, prompt data, or modification data from one or more of the secured computing system 180 or the user computing system 190.

At block 380, the process 300 involves generating modified candidate mnemonic data by the multi-perspective evaluation system. In addition, the modified candidate mnemonic data includes one or more additional media data objects or a modified media data object (e.g., modification to a media data object included in the candidate mnemonic data). In some cases, the mnemonic generation model determines a modified set of candidate features for the modified candidate login data. For example, the mnemonic generation model 230 modifies the candidate login features 225 based on modification data or prompt data included in the user input data 287. Additionally or alternatively, the mnemonic generation model determines a modified group of media data objects based on a comparison of the modified candidate features with the media features (e.g., for the set of media data). Based on the modified group of media data objects, the mnemonic generation model generates a modified candidate mnemonic data. For example, the mnemonic generation model 230 modifies the candidate mnemonic data 240 based on the modified candidate login features 225, such as by including an additional media data object from the media data 215 or by modifying a media data object that is included in the candidate mnemonic data 240.

In some cases, the modified candidate mnemonic data can provide memory assistance for modifiable or non-modifiable portions of the candidate login data. For example, the candidate login data described in regard to process 300 could indicate modifiable login data and non-modifiable login data. In addition, the multi-perspective evaluation system could receive modification data that indicates a requested change to the modifiable portion of the candidate login data. Based on the modification data, the multi-perspective evaluation system could modify one or more of the candidate login data or the candidate mnemonic data. In addition, the multi-perspective evaluation system described in regard to process 300 could receive prompt data that indicates a requested change to the candidate mnemonic data with regard to the non-modifiable login data, such as biometric data or a passphrase. Based on the modification data or prompt data, the multi-perspective evaluation system could modify the candidate mnemonic data without modifying the candidate login data. For example, the multi-perspective evaluation system 210 could determine that the user input data 287 includes prompt data requesting a change to the candidate mnemonic data 240 related to a portion of non-modifiable login data in the candidate login data 220. For example, if the candidate login data 220 indicates biometric data for a fingerprint of the user's left ring finger, the prompt data could request a change to the candidate mnemonic data 240 that includes adding an image of a left-handed glove with the third glove finger depicted in a different color. In addition, the mnemonic generation model 230 could determine additional features of the prompt data and modify the candidate mnemonic data 240 based on the combination of the candidate features of the candidate login data 220 with the additional features of the prompt data. In this example, the multi-perspective evaluation system 210 can improve memory assistance provided by the modified candidate mnemonic data 240 for the candidate login data 220 (e.g., which finger to use for user login), without modifying the candidate login data 220.

At block 390, the process 300 involves generating modified login guess data by the multi-perspective evaluation system. In some cases, the mnemonic evaluation model generates a set of modified guess features for the modified candidate mnemonic data. Based on the modified guess features, the mnemonic evaluation model generates the modified login guess data. In addition, the modified login guess data includes at least one login guess data object that describes at least one of the modified guess features that describe the modified candidate mnemonic data, such as an additional media feature for an additional media data object. In some cases, the multi-perspective evaluation system limits data access of the mnemonic evaluation model, such as permitting access to the modified candidate mnemonic data by the mnemonic evaluation model and restricting access, by the mnemonic evaluation model, to one or more of modification data, prompt data, modified candidate login data, or other data objects related to a requested modification to the mcd or the candidate login data. For example, the mnemonic evaluation model 250 modifies the mnemonic guess features 245 that describe the modified candidate mnemonic data 240. In addition, the mnemonic evaluation model 250 generates the modified login guess data 260 based on the modified mnemonic guess features 245.

At block 395, the process 300 involves providing, by the multi-perspective evaluation system, one or more of the modified candidate mnemonic data or the modified login guess data to one or more additional computing systems. For example, the multi-perspective evaluation system 210 provides one or more of the modified candidate mnemonic data 240 or the modified login guess data 260 to at least one additional computing system (e.g., the user computing system 190 or the secured computing system 180). In some cases, the additional computing system is configured to present the modified login guess data or the modified candidate mnemonic data, e.g., via a user interface. Additionally or alternatively, the additional computing system is configured to determine at least one relationship based on the modified login guess data or the modified candidate mnemonic data, e.g., an additional security relationship or an additional assistance relationship.

In some embodiments, operations related one or more blocks in FIG. 3 or 4 are repeated. For example, operations related to one or more of blocks 370-395 can be repeated for additional modification data, prompt data, or alert data received by the example multi-perspective evaluation system until one or more relationships among the candidate login data, candidate mnemonic data, and login guess data are fulfilled, e.g., the multi-perspective evaluation system determines that a security relationship is fulfilled (e.g., the login guess data is dissimilar from the candidate login data) and that an assistance relationship is fulfilled (e.g., the candidate mnemonic data provides sufficient memory assistance for the candidate login data). For example, the multi-perspective evaluation system 110 could generate multiple versions of candidate login data or candidate mnemonic data based on multiple versions of modification data, prompt data, or alert data, e.g., repeating operations related to FIG. 3 or 4 until approval data is received. Additionally or alternatively, the multi-perspective evaluation system 110 could exchange information with one or more of the user computing system 190 or the secured computing system 180 via a suitable communication technique to exchange descriptive information, such as a chatbot or API configured to exchange the multiple versions of candidate login data, candidate mnemonic data, modification data, prompt data, alert data, or approval data.

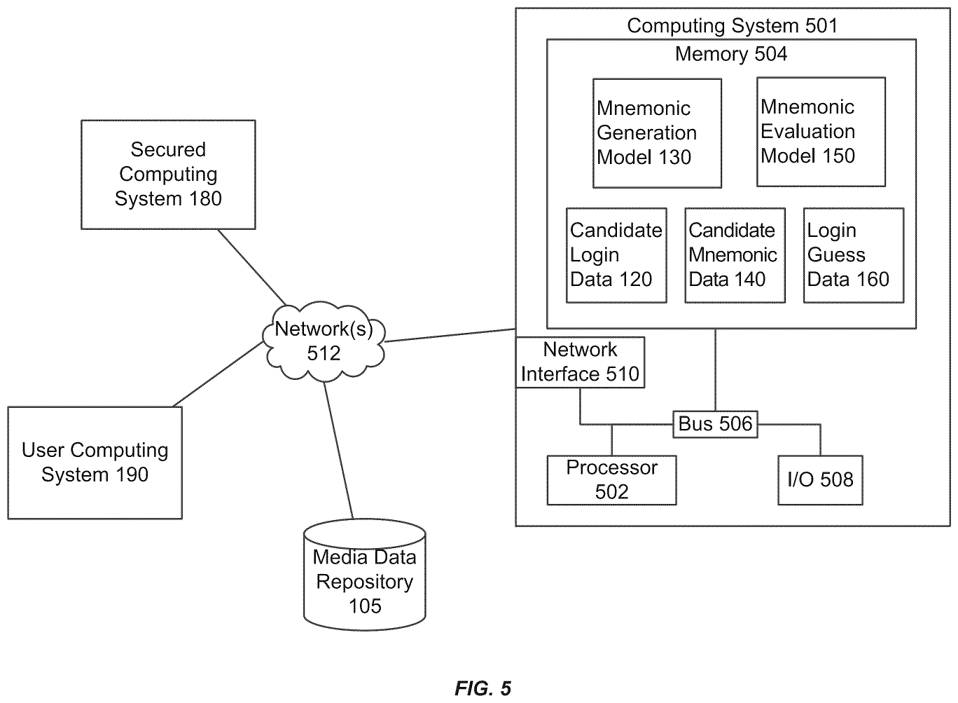

Any suitable computing system or group of computing systems can be used for performing the operations described herein. For example, FIG. 5 is a block diagram depicting a computing system configured to implement a multi-perspective login data evaluation computing system, according to certain embodiments.

The depicted example of a computing system 501 includes one or more processors 502 communicatively coupled to one or more memory devices 504. The processor 502 executes computer-executable program code or accesses information stored in the memory device 504. Examples of processor 502 include a microprocessor, an application-specific integrated circuit (“ASIC”), a field-programmable gate array (“FPGA”), or other suitable processing device. The processor 502 can include any number of processing devices, including one.

The memory device 504 includes any suitable non-transitory computer-readable medium for storing the mnemonic generation model 130, the mnemonic evaluation model 150, the candidate login data 120, the candidate mnemonic data 140, the login guess data 160, and other received or determined values or data objects. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 501 may also include a number of external or internal devices such as input or output devices. For example, the computing system 501 is shown with an input/output (“I/O”) interface 508 that can receive input from input devices or provide output to output devices. A bus 506 can also be included in the computing system 501. The bus 506 can communicatively couple one or more components of the computing system 501.

The computing system 501 executes program code that configures the processor 502 to perform one or more of the operations described above with respect to FIGS. 1-4. The program code includes operations related to, for example, one or more of the mnemonic generation model 130, the mnemonic evaluation model 150, the candidate login data 120, the candidate mnemonic data 140, the login guess data 160, or other suitable applications or memory structures that perform one or more operations described herein. The program code may be resident in the memory device 504 or any suitable computer-readable medium and may be executed by the processor 502 or any other suitable processor. In some embodiments, the program code described above, the mnemonic generation model 130, the mnemonic evaluation model 150, the candidate login data 120, the candidate mnemonic data 140, and the login guess data 160 are stored in the memory device 504, as depicted in FIG. 5. In additional or alternative embodiments, one or more of the mnemonic generation model 130, the mnemonic evaluation model 150, the candidate login data 120, the candidate mnemonic data 140, the login guess data 160, and the program code described above are stored in one or more memory devices accessible via a data network, such as a memory device accessible via a cloud service.

The computing system 501 depicted in FIG. 5 also includes at least one network interface 510. The network interface 510 includes any device or group of devices suitable for establishing a wired or wireless data connection to one or more data networks 512. Non-limiting examples of the network interface 510 include an Ethernet network adapter, a modem, and/or the like. One or more additional computing systems are connected to the computing system 501 via the networks 512, such as the user computing system 190, the secured computing system 180, or the media data repository 105. The computing system 501 is able to communicate with one or more of the user computing system 190, the secured computing system 180, or the media data repository 105 using the network interface 510. Although FIG. 5 depicts the media data repository 105 as connected to computing system 501 via the networks 512, other embodiments are possible, including the media data repository 105 running as a data storage structure in the memory device 504 of the computing system 501, or implemented as an additional component of the computing system 501.

### GENERAL CONSIDERATIONS

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. A system for multi-perspective evaluation of login data, the system comprising a processor and a storage device storing instructions that are executable by the processor, the processor being configured to execute:
a trained mnemonic generation model and a trained mnemonic evaluation model,
wherein the trained mnemonic generation model is configured for:
receiving candidate login data that includes a candidate password for a secured computing system; and
generating candidate mnemonic data that includes media data associated with the candidate login data;
wherein the trained mnemonic evaluation model is configured for:
determining mnemonic guess features of the candidate mnemonic data; and
generating login guess data that is based on at least one of the mnemonic guess features of the candidate mnemonic data, the login guess data including at least one text string;
wherein the processor is further configured for:
providing the login guess data to an additional computing system, the additional computing system being configured to present the login guess data via a display device; and
responsive to receiving, from the additional computing system, approval data indicating that the login guess data is dissimilar from the candidate login data, providing user profile data to the secured computing system, the user profile data being based on the candidate login data.

2. The system of claim 1, wherein the user profile data for the secured computing system includes one or more of:
i) password data that includes the candidate password, or
ii) the candidate mnemonic data.

3. The system of claim 1, the processor being configured for:
receiving, from the additional computing system, prompt data describing a modification to the candidate mnemonic data;
generating, by the trained mnemonic generation model, modified candidate mnemonic data that includes modified media data corresponding to a combination of the prompt data with one or more of: i) the media data or ii) the candidate login data; and
generating, by the trained mnemonic evaluation model and based on the modified candidate mnemonic data, modified login guess data that includes at least one additional text string.

4. The system of claim 1, the processor being configured for:
determining, by the trained mnemonic generation model, a feature set that describes candidate features of the candidate login data,
wherein generating the candidate mnemonic data includes:
comparing one or more of the candidate features to media features describing the media data;
determining, based on the comparison, a similarity relationship between the media data and the one or more of the candidate features of the candidate login data; and
selecting one or more portions of the media data based on the similarity relationship.

5. The system of claim 1, the processor being configured for:
determining, by the trained mnemonic evaluation model, a feature set that describes the mnemonic guess features of the candidate mnemonic data,
wherein generating the login guess data includes:
identifying, from the candidate mnemonic data, the mnemonic guess features; and
generating, based on the mnemonic guess features, the at least one text string.

6. The system of claim 1, wherein the trained mnemonic evaluation model generates the at least one text string based on a combination of the mnemonic guess features of the candidate mnemonic data with one or more of:
i) first additional features describing criteria for login data of the secured computing system, or
ii) second additional features describing publicly available user history data.

7. The system of claim 1, wherein the trained mnemonic generation model generates the candidate mnemonic data based on a combination of candidate features of the candidate login data with one or more of:
i) publicly available user history data, or
ii) privately available user history data.

8. A method including operations executed by a processor, the operations comprising:
receiving, by a trained mnemonic generation model, candidate login data for a secured computing system;
generating, by the trained mnemonic generation model, candidate mnemonic data that includes media data associated with the candidate login data;
determining, by a trained mnemonic evaluation model, mnemonic guess features of the candidate mnemonic data;
generating, by the trained mnemonic evaluation model, login guess data that is based on at least one of the mnemonic guess features of the candidate mnemonic data, the login guess data including at least one login guess data object;
providing the login guess data to an additional computing system, the additional computing system being configured to present the login guess data via an output device; and
responsive to receiving, from the additional computing system, approval data indicating a relationship among the candidate login data, the candidate mnemonic data, or the login guess data, providing user profile data to the secured computing system, the user profile data being based on the candidate login data.

9. The method of claim 8, wherein the user profile data for the secured computing system includes one or more of:
i) login data that includes the candidate login data, or
ii) the candidate mnemonic data.

10. The method of claim 8, the operations further comprising:
receiving, from the additional computing system, prompt data describing a modification to the candidate mnemonic data;
generating, by the trained mnemonic generation model, modified candidate mnemonic data that includes modified media data corresponding to a combination of the prompt data with one or more of: i) the media data or ii) the candidate login data; and
generating, by the trained mnemonic evaluation model and based on the modified candidate mnemonic data, modified login guess data that includes at least one additional login guess data object.

11. The method of claim 8, the operations further comprising:
determining, by the trained mnemonic generation model, a feature set that describes candidate features of the candidate login data,
wherein generating the candidate mnemonic data includes:
comparing one or more of the candidate features to media features describing the media data;
determining, based on the comparison, a similarity relationship between the media data and the one or more of the candidate features of the candidate login data; and
selecting one or more portions of the media data based on the similarity relationship.

12. The method of claim 8, the operations further comprising:
determining, by the trained mnemonic evaluation model, a feature set that describes the mnemonic guess features of the candidate mnemonic data,
wherein generating the login guess data includes:
identifying, from the candidate mnemonic data, the mnemonic guess features; and
generating, based on the mnemonic guess features, the at least one login guess data object.

13. The method of claim 8, wherein the trained mnemonic evaluation model generates the at least one login guess data object based on a combination of the mnemonic guess features of the candidate mnemonic data with one or more of:
i) first additional features describing criteria for login data of the secured computing system, or
ii) second additional features describing publicly available user history data.

14. The method of claim 8, wherein the trained mnemonic generation model generates the candidate mnemonic data based on a combination of candidate features of the candidate login data with one or more of:
i) publicly available user history data, or
ii) privately available user history data.

15. A non-transitory computer-readable medium embodying program code that, when executed by a processor, causes the processor to perform operations comprising:
receiving, by a trained mnemonic generation model, candidate login data for a secured computing system;
generating, by the trained mnemonic generation model, candidate mnemonic data that includes media data associated with the candidate login data;
determining, by a trained mnemonic evaluation model, mnemonic guess features of the candidate mnemonic data;
generating, by the trained mnemonic evaluation model, login guess data that is based on at least one of the mnemonic guess features of the candidate mnemonic data, the login guess data including at least one login guess data object;
providing the login guess data to an additional computing system, the additional computing system being configured to present the login guess data via an output device; and
responsive to receiving, from the additional computing system, approval data indicating a relationship among the candidate login data, the candidate mnemonic data, or the login guess data, providing user profile data to the secured computing system, the user profile data being based on the candidate login data.

16. The non-transitory computer-readable medium of claim 15, wherein the user profile data for the secured computing system includes one or more of:
i) login data that includes the candidate login data, or
ii) the candidate mnemonic data.

17. The non-transitory computer-readable medium of claim 15, the operations further comprising:
receiving, from the additional computing system, prompt data describing a modification to the candidate mnemonic data;
generating, by the trained mnemonic generation model, modified candidate mnemonic data that includes modified media data corresponding to a combination of the prompt data with one or more of: i) the media data or ii) the candidate login data; and
generating, by the trained mnemonic evaluation model and based on the modified candidate mnemonic data, modified login guess data that includes at least one additional login guess data object.

18. The non-transitory computer-readable medium of claim 15, the operations further comprising:
determining, by the trained mnemonic generation model, a feature set that describes candidate features of the candidate login data,
wherein generating the candidate mnemonic data includes:
comparing one or more of the candidate features to media features describing the media data;
determining, based on the comparison, a similarity relationship between the media data and the one or more of the candidate features of the candidate login data; and
selecting one or more portions of the media data based on the similarity relationship.

19. The non-transitory computer-readable medium of claim 15, the operations further comprising:
determining, by the trained mnemonic evaluation model, a feature set that describes the mnemonic guess features of the candidate mnemonic data,
wherein generating the login guess data includes:
identifying, from the candidate mnemonic data, the mnemonic guess features; and
generating, based on the mnemonic guess features, the at least one login guess data object.

20. The non-transitory computer-readable medium of claim 15, wherein the trained mnemonic evaluation model generates the at least one login guess data object based on a combination of the mnemonic guess features of the candidate mnemonic data with one or more of:
i) first additional features describing criteria for login data of the secured computing system, or
ii) second additional features describing publicly available user history data.
